(19) United States
(12) Patent Application Publication
(10) Pub. No.: US 2022/0110274 A1
(43) Pub. Date: Apr. 14, 2022

(54) UNIFORM MONOSEEDING AND CULTIVATION METHOD OF WINTER WHEAT IN HUANG-HUAI-HAI REGION

(71) Applicant: CROP RESEARCH INSTITUTE, SHANDONG ACADEMY OF AGRICULTURAL SCIENCES, Jinan (CN)

(72) Inventors: Shengdong LI, Jinan (CN); Shutang LIU, Jinan (CN); Zongxin LI, Jinan (CN); Bo FENG, Jinan (CN); Xiangjun BI, Jinan (CN); Zongshuai WANG, Jinan (CN); Kaichang LIU, Jinan (CN); Haijun ZHAO, Jinan (CN); Fahong WANG, Jinan (CN); Bin ZHANG, Jinan (CN)

(21) Appl. No.: 17/232,024

(22) Filed: Apr. 15, 2021

(30) Foreign Application Priority Data
Oct. 14, 2020 (CN) 202011097617.1

(51) Int. Cl. A01G 22/20; A01B 79/02; A01C 7/08

(52) U.S. Cl. CPC A01G 22/20; A01C 7/085; A01B 79/02

(57) ABSTRACT

The present disclosure relates to the technical field of wheat planting, and in particular to a uniform monoseeding and cultivation method of winter wheat in Huang-huai-hai region. The cultivation method includes seedbed finishing and precision seeding; after seedbed finishing during winter wheat seeding creates excellent seedbed conditions, precision monoseeding of winter wheat is implemented by a seeder according to precise agronomic index requirements including plant spacing, row spacing, seeding depth, and seeding rate, concurrently achieving the objectives of consistent covering depth and deep placement of bottom fertilizer. The cultivation method can make the most of light, heat, water, and fertilizer resources, and precisely optimize the plant spacing, row spacing, and seeding depth during seeding to integrate mechanized seeding management of winter wheat in Huang-huai-hai region, achieving objectives of building excellent crop community and increasing yield and efficiency.

### CROSS-REFERENCE TO RELATED APPLICATIONS

This application is a claims priority to Chinese Application No. 202011097617.1, filed Oct. 14, 2020, under 35 U.S.C. § 119(a). The above-referenced patent application is incorporated by reference in its entirety.

### BACKGROUND OF THE INVENTION

### Field of the Invention

The present disclosure relates to the technical field of wheat planting, and in particular to a uniform monoseeding and cultivation method of winter wheat in Huang-huai-hai region.

### Description of the Related Technology

In China, wheat is the third largest food crop next only to rice and corn. The annual planting area of wheat accounts for about 22% of the total grain area, and its total output accounts for about 21% of the total grain output. The wheat is of great significance for maintaining national food security and social stability. Huanghuai Winter Wheat Area with excellent natural ecological conditions is the most suitable area for wheat growth in China, where wheat area and total output account for about 45% and 48% of the national wheat field area and total output, respectively. For a long time, the wheat production in this area is faced with many problems such as multiple and chaotic planting patterns, high seeding rate, poor seeding quality, and extensive management, which have serious effects on the high-quality development of wheat production.

Main seeding methods in Huanghuai Winter Wheat Area include strip seeding, wide-width seeding, and no-tillage seeding. Strip seeding refers to a planting pattern for leveling the ground, bedding, furrowing (with a furrow depth of about 1-2 cm) before seeding, broadcast sowing wheat seed in furrows, earthing up, and leveling the ground. Taking wheat planting in Shandong as an example, the row spacing of strip-seeded wheat is about 15-30 cm, and the drilling width is about 3-4 cm. Although this method is the most common seeding method in wheat production so far, there are common problems about narrow drilling width, no plant spacing, agglomeration and uneven distribution of grains, fierce competition among individuals, and weak root systems. At the same time, this conventional drill seeding method is prone to inaccurate land preparation, serious soil clods, and poor ventilation and light penetration conditions in the field, resulting in missing wheat seedlings and broken ridges, which are not conducive to the increase of grain yield. Wide-width seeding is an innovation and development based on strip seeding of wheat. The drilling width is increased to 6-10 cm, and the row spacing is increased by about 5-6 cm. By expanding the growth and development space of individual wheat plant, the quality of wheat population is improved, and individual quality is increased, realizing the leap from high-yield wheat to super-high-yield wheat. However, wide-width seeding has some defects, such as too dense seeding, crowded plants, competition for light, vigorous growth, and fewer tillers. No-tillage seeding is a kind of protective tillage method that covers the ground with crop straw to improve soil fertility and drought resistance based on the principle of reducing soil disturbance as much as possible. Such reduced-tilling or no-tillage method has the advantage of improving soil moisture conservation performance. For example, leaving high stubble remains to cover the earth's surface can prevent direct sunlight on the ground, which can reduce soil water evaporation and surface rainwater runoff, playing a role in soil water evaporation. However, these stubble remains have some hidden troubles. Decaying straw consumes substantial soil nitrogen. Thus, timely nitrogen supplementation is required in agricultural production, which not only increases the agricultural production cost, but also reduces the nitrogen use efficiency. Moreover, reducing the cultivation of the soil is not conducive to wheat rooting, and problems such as uneven emergence and poor population quality may occur in the later growth of wheat.

All of the above-mentioned conventional cultivation methods adopt an extensive and high-seeding cultivation pattern. FIG. 1 shows a conventional seeding method. During seeding, the row spacing is set highly, and grains are gathered without plant spacing. There are certain defects in the emergence of wheat. These problems are largely attributable to the clustered seeding of wheat, the germination rate and uniformity are affected, there is competition among individual seeds, and wheat individuals compete for water, fertilizers, and sunlight. Ultimately, the growth and development of wheat are inhibited, which is extremely prone to poor population quality, compact space, strong seedlings bullying weaker ones, weak seedlings, susceptibility to lodging, low tillering rate, and reduced yield. This not only causes the waste of seeds, but also increases the agricultural production cost.

In another aspect, unscientific land preparation increases production costs of seeds and mechanical operations, and indirectly reduces farmers' income and production enthusiasm.

There are a plurality of common seeding methods of winter wheat in Huang-huai-hai region, such as strip seeding, wide-width seeding, and no-tillage seeding. A sufficient number of populations are the basic guarantee for high wheat yield. The planting density determines the population size, and appropriate density is a basic measure to create a reasonable dynamic population structure and form an optimized yield composition. Therefore, starting from the wheat seeding link, the present disclosure is targeted to set forth a uniform monoseeding and cultivation method of winter wheat in Huang-huai-hai region.

### SUMMARY

In current wheat production, intense seeding and unscientific land preparation lead to fierce competition among wheat individuals, resulting in a fact that low uniformity of seedling emergence, poor population quality, weak seedlings, low tillering efficiency, and low yield are commonly found in wheat populations in Huang-huai-hai region. In view of these problems, the present disclosure is targeted to provide a uniform monoseeding and cultivation method of winter wheat in Huang-huai-hai region in combination with competition for water and nutrients during wheat growth. In the cultivation method, after seedbed finishing during winter wheat seeding creates excellent seedbed conditions, precision monoseeding of winter wheat is implemented by a wheat uniform monoseeder (W-2019D407) according to precise agronomic index requirements including plant spacing, row spacing, seeding depth, and seeding rate, concurrently achieving the objectives of consistent covering depth and deep placement of bottom fertilizer. The cultivation method can make the most of light, heat, water, and fertilizer resources, and precisely optimize the plant spacing, row spacing, and seeding depth during seeding to integrate mechanized seeding management of winter wheat in Huang-huai-hai region, achieving objectives of building excellent crop community and increasing yield and efficiency.

The technical solution of the present disclosure is:
a uniform monoseeding and cultivation method of winter wheat in Huang-huai-hai region, including seedbed finishing step and precision seeding.

(1) Seedbed Finishing

High-quality and standardized land preparation technology can improve the quality of land preparation and lay an excellent foundation for wheat seeding. Overall requirements for wheat land preparation are: combination of tillage and rotation, fine crushing and leveling; before wheat seeding, soil is subjected to deep tillage (once) and rotary tillage (twice or thrice) using a rotary tiller; the depth of the deep tillage is required to be 23-25 cm, aiming at breaking the plough pan, improving soil structure, and promoting normal rooting and growth after wheat seeding. After the rotary tillage, the soil needs to reach a state where top soil is loose and bottom soil is solid without unevenness, for fear of later uneven seedling emergence.

(2) Precision Seeding

Wheat seed are screened and dressed before seeding: the purity standard of sown wheat basic seed is required to be not less than 99.9%, the purity of quality seed is required to be not less than 99%, and the cleanliness, germination rate, and moisture content of the wheat basic and quality seeds are required to be not less than 98%, no less than 85%, and not more than 13% (based on wet weight), respectively; under the premise of high-quality land preparation, a seeder is used for precision monoseeding of wheat. The seeder sets wheat row spacing to be 4-6 cm, plant spacing to be 3-5 cm, and seeding depth to be 3-4 cm, and when seeding, timely compaction after seeding is required to ensure the compaction pressure and quality, reduce the possibility of water consuming due to soil aeration, and improve drought and frost resistance in wheat.

Further, in step (1), the seeder may be a wheat uniform monoseeder (W-2019D407) trial-produced by Shandong Dahua Machinery Co., Ltd.

Further, in the method of the present disclosure, due to a longer growth period, the winter wheat in Huang-huai-hai region may be seeded in early-to-mid October and harvested from the end of May through early-to-mid June.

Further, in step (1), the deep tillage may be carried out once every two years, to reduce the cost of land preparation and the disturbance to the cultivated land to a greater extent, and to better conserve soil moisture.

Further, in step (1), the wheat has a long growth period and high water requirement, and before seeding, 30 m³/mu water may be irrigated to moisten the soil, replenishing water for deep root growth.

Further, in step (1), for large clods in a plot, further harrowing may be required to make topsoil depth consistent, and promote a balanced increase in wheat production at the later stage.

Further, in step (2), the seeder may set the wheat row spacing to be 5 cm, the plant spacing to be 3 cm, and the seeding depth to be 3 cm.

Further, in step (2), before seeding, 1% shenqinmycin may be used for seed dressing; treatment at the concentration may control root rot, wheat sheath blight, and soil insects well.

Further, in step (2), seeding rate may be controlled at 30-40 catty/mu, and more preferably 35 catty/mu, in order to ensure sufficient basic seedlings in the wheat field.

The present disclosure has the following beneficial effects:

This method may substantially reduce the wide row spacing of conventional wheat seeding to 5 cm, change the wheat seeding method from the original clustered broadcast sowing to the dispersed monoseeding, and adjust the plant spacing from 0 cm to 3-5 cm. At the same time, the seeding depth of wheat may be precisely controlled to 3 cm during seeding. The uniform monoseeding technology may effectively improve the strong competition for water, nutrients, light and heat resources generated by the agglomeration of wheat grains during wheat growth, and ensure the balanced growth of wheat individuals and high uniformity of seedling emergence. The construction of excellent populations at the early stage may contribute to improvement of the earbearing tiller percentage of the wheat at the late growth stage, laying a solid foundation for efficient production.

The method of the present disclosure, by changing the disadvantages of the conventional seeding method in winter wheat planting in Huang-huai-hai region, does not simply change the row spacing of wheat seeding, but breaks the tradition of no plant spacing in conventional mechanical seeding of wheat; in combination with scientific land preparation methods, the method may integrate various resources during wheat production, enable these resources to closely match the wheat growth, and optimize each link from the seeding, ensure the effective exertion of the potential of wheat individuals, and contribute to the increase in yield.

In a word, the present disclosure may change the conventional seeding method to implement dispersed monoseeding, set a certain seed spacing, reduce seed row spacing, ensure that the wheat has enough space for balanced growth, and avoid weak seedlings from being bullied by strong seedlings; this will be conducive to high yield and high efficiency in wheat production, fully improve the utilization of wheat seeds on land, water and fertilizer resources, favor the cultivation of strong seedlings, promote later tillering and earing of wheat, and increase grain yield by increasing the number of ears per mu of field wheat. The present disclosure may effectively guarantee the excellent construction of wheat population from the initial stage of production.

The method of the present disclosure optimizes the wheat growth space. Thus, the method may improve the field ventilation and light transmittance for the subsequently growing wheat, cultivate robust individuals, increase the utilization rate of light, heat, water, temperature, and land resources, promote the uniform, regular and strong seedlings to increase yield and harvest, and significantly improve agricultural productivity.

### BRIEF DESCRIPTION OF THE DRAWINGS

To describe the technical solutions in the examples of the present disclosure or in the prior art more clearly, the following will briefly introduce the drawings that need to be used in the description of the embodiments or the prior art. Obviously, other drawings can be obtained by those of ordinary skill in the art based on these drawings without creative work.

FIG. 1 is a schematic diagram of a conventional wheat seeding method in the background of the present disclosure;

FIG. 2 is a schematic diagram of the uniform monoseeding and cultivation method of winter wheat of the present disclosure.

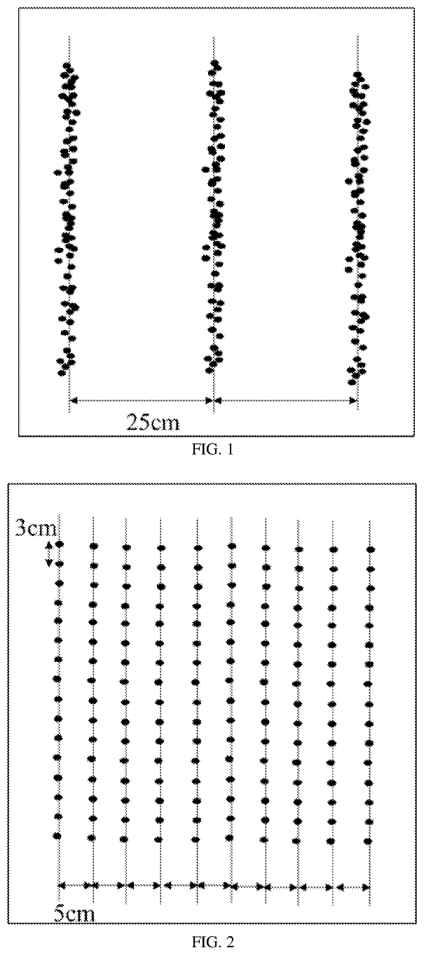

### DETAILED DESCRIPTION

To enable those skilled in the art to better understand the technical solution in the present disclosure, the technical solutions in the examples of the present disclosure will be clearly and completely described below with reference to the accompanying drawings in the examples of the present disclosure. Obviously, the described examples are only a part of, not all of, the examples of the present disclosure. Based on the examples of the present disclosure, all other embodiments obtained by those of ordinary skill in the art without creative work shall fall within the protection scope of the present disclosure.

A uniform monoseeding and cultivation method of winter wheat in Huang-huai-hai region provided by the present disclosure includes seedbed finishing and precision seeding; in the method of the present disclosure, due to a longer growth period, the winter wheat in Huang-huai-hai region may be seeded in early-to-mid October and harvested from the end of May through early-to-mid June.

(1) Seedbed Finishing

High-quality and standardized land preparation technology can improve the quality of land preparation and lay an excellent foundation for wheat seeding. Overall requirements for wheat land preparation are: combination of tillage and rotation, fine crushing and leveling; before wheat seeding, soil is subjected to deep tillage (once) and rotary tillage (twice or thrice) using a rotary tiller; the depth of the deep tillage is required to be 23-25 cm, aiming at breaking the plough pan, improving soil structure, and promoting normal rooting and growth after wheat seeding. After the rotary tillage, the soil needs to reach a state where top soil is loose and bottom soil is solid without unevenness, for fear of later uneven seedling emergence. For large clods in a plot, further harrowing may be required to make topsoil depth consistent, and promote a balanced increase in wheat production at the later stage.

The wheat has a long growth period and high water requirement, and before seeding, 30 m³ water may be irrigated to moisten the soil, replenishing water for deep root growth.

(2) Precision Seeding

Wheat seed are screened and dressed before seeding: the purity standard of sown wheat basic seed is required to be not less than 99.9%, the purity of quality seed is required to be not less than 99%, and the cleanliness, germination rate, and moisture content of the wheat basic and quality seeds are required to be not less than 98%, no less than 85%, and not more than 13% (based on wet weight), respectively; before seeding, 1% shenqinmycin may be used for seed dressing; treatment at the concentration may control root rot, wheat sheath blight, and soil insects well.

Under the premise of high-quality land preparation, a seeder is used for precision monoseeding of wheat. The seeder may set wheat row spacing to be 4-6 cm, plant spacing to be 3-5 cm, and seeding depth to be 3 cm, and when seeding, timely compaction after seeding may be required to ensure the compaction pressure and quality, reduce the possibility of water consuming due to soil aeration, and improve drought and frost resistance in wheat. The seeding rate may be controlled at 30-40 catty/mu.

The deep tillage may be carried out once every two years, to reduce the cost of land preparation and the disturbance to the cultivated land to a greater extent, and to better conserve soil moisture.

The following examples of the present disclosure are specific examples of test fields carried out according to the above-mentioned cultivation method.

### Example 1

This example was carried out in a test field in Jingzhi Town, Anqiu, Weifang, Shandong Province from 2019 to 2020, with an area of 1,400 mu. The tested wheat cultivar was Triticum aestivum ‘Jimai 22’ (bred by Crop Research Institute, Shandong Academy of Agricultural Sciences). Before seeding, the plot was subjected to deep tillage (once) and rotary tillage (twice) on Oct. 5, 2019. The depth of deep tillage was 23 cm. At the same time, ploughing and harrowing were performed to level the ground, and irrigation was performed once. Before wheat seeding, 1% shenqinmycin was used for seed dressing. On Oct. 8, 2019, a wheat uniform monoseeder (W-2019D407) was used for seeding. As shown in FIG. 2, the wheat row spacing is 5 cm, the plant spacing is 3 cm, the seeding depth is 3 cm, and the seeding rate is 17.5 kg/mu. The wheat of this example was harvested on Jun. 18, 2020.

### Comparative Example 1

This comparative example was carried out in a test field in Jingzhi Town, Anqiu, Weifang, Shandong Province, with an area of 6,600 m². The land preparation and seeding date and cultivar of wheat were the same as those in Example 1. In the comparative example, seeding was done by a conventional strip seeder, and specially 2BXF-12 Wheat Seed Drill manufactured by Hebei Nonghaha Machinery Group Co., Ltd. As shown in FIG. 2, the wheat row spacing is 25 cm, the seeding depth is 5 cm, and the wheat seeding rate is 12 kg/mu. The wheat of the comparative example was harvested on June 17.

The test results of Example 1 and Comparative Example 1 are compared as follows:

The earbearing tiller percentage of the wheat in the experimental plot using the cultivation method of Example 1 was 54%. The yield and three yield components were as follows: the number of ears per mu was 491,000 ears per mu, the grain number per ear was 37.5 grains per ear, the thousand-grain weight was 42.1 g, and the actual output was 705.4 kg/mu.

The earbearing tiller percentage of the wheat in the experimental plot using strip seeding of Comparative Example 1 was 45%. The yield and three yield components were as follows: the number of ears per mu was 416,000 ears per mu, the grain number per ear was 30.1 grains per ear, the thousand-grain weight was 34.7 g, and the actual output was 500.3 kg/mu.

By comparing the results of the above-mentioned earbearing tiller percentage, yield, and three yield components, it is found that the cultivation method of Example 1 increased the earbearing tiller percentage by 9%, the number of ears per mu by 18.0%, the grain number per ear by 24.6%, the thousand-grain weight by 21.3%, and the actual output by 41.0% in the context of the same seeding rate. The cultivation method of Example 1 increased the earbearing tiller percentage, the three yield components, and the yield, indicating that more individual wheat resources under the planting conditions of the present disclosure were harvested, the wheat grew and developed vigorously, and the yield increased; while in the comparative example, the strip seeding, due to insufficient land resource utilization, resulted in low earbearing tiller percentage, and the potential wheat yield was not fully exerted.

### Example 2

This example was implemented in Zhouzhuang Village, Jiaomiao Town, Qihe County, Dezhou, Shandong Province from 2019 to 2020. The soil of this plot is loam; the wheat cultivar was high-quality special wheat Triticum aestivum ‘Jimai 44’. Before wheat seeding, the plot was subjected to deep tillage (once) and rotary tillage (twice). The depth of deep tillage was 25 cm. At the same time, ploughing, harrowing and irrigation were performed. Before wheat seeding, 1% shenqinmycin was used for seed dressing. On Oct. 10, 2019, a wheat uniform monoseeder (W-2019D407) was used for seeding. The wheat row spacing was 5 cm, the plant spacing was 3 cm, the seeding rate was 16.8 kg/mu, and the seeding depth was 3 cm. The wheat of this example was harvested on Jun. 22, 2020.

### Comparative Example 2

This comparative example was carried out in a plot provided by in Jingzhi Town, Anqiu, Weifang, Shandong Province. The land preparation and seeding date and cultivar of wheat were the same as those in Example 2. In the comparative example, seeding was done by a wide-width seeder, and the seeder was Yunnong-2BJK6 Precision Wheat Seed Drill. The wheat row spacing was 22 cm, the seeding strip depth was 5 cm, the seeding depth was 5 cm, and the seeding rate was 14 kg/mu. The wheat in the control plot was harvested on Jun. 22, 2020.

The test results of Example 2 and Comparative Example 2 are compared as follows:

The earbearing tiller percentage of the wheat in the experimental plot using the cultivation method of Example 2 was 52%. The yield and three yield components were as follows: the number of ears per mu was 459,000 ears per mu, the grain number per ear was 37.0 grains per ear, the thousand-grain weight was 41.5 g, and the actual output was 630.5 kg/mu.

The earbearing tiller percentage of the wheat in the experimental plot using wide-width seeding of Comparative Example 2 was 46%. The yield and three yield components were as follows: the number of ears per mu was 431,000 ears per mu, the grain number per ear was 33.2 grains per ear, the thousand-grain weight was 36.2 g, and the actual output was 513.3 kg/mu.

By comparing the results of the above-mentioned earbearing tiller percentage, yield, and three yield components, it is found that the cultivation method of Example 2 increased the earbearing tiller percentage by 6%, the number of ears per mu by 6.5%, the grain number per ear by 11.4%, the thousand-grain weight by 14.6%, and the actual output by 22.8% in the context of unchanged seeding rate. It concludes that the present disclosure has promoting effects on the wheat tiller formation rate and yield components.

Although the present disclosure has been described in detail with reference to the accompanying drawings and in combination with the preferred examples, the present disclosure is not limited thereto. Without departing from the spirit and essence of the present disclosure, those of ordinary skill in the art can make various equivalent modifications or substitutions to the examples of the present disclosure, and these modifications or substitutions should fall within the scope of the present disclosure/all changes or substitutions conceived by any person skilled in the art within the technical scope disclosed by the present disclosure should fall within the protection scope of the present disclosure. Therefore, the protection scope of the present disclosure shall be the protection scope of the claims.

What is claimed is:

1. A uniform monoseeding and cultivation method of winter wheat, comprising seedbed finishing and precision seeding; wherein
(1) seedbed finishing
overall requirements for wheat land preparation are: combination of tillage and rotation, fine crushing and leveling; before wheat seeding, soil is subjected to deep tillage (once) and rotary tillage (twice or thrice) using a rotary tiller; the depth of the deep tillage is required to be 23-25 cm; after the rotary tillage, the soil needs to reach a state where top soil is loose and bottom soil is solid without unevenness;
(2) precision seeding
screening and dressing wheat seed before seeding, wherein the purity standard of sown wheat basic seed is required to be not less than 99.9%, the purity of quality seed is required to be not less than 99%, and the cleanliness, germination rate, and moisture content of the wheat basic and quality seeds are required to be not less than 98%, no less than 85%, and not more than 13% (based on wet weight), respectively; and using a seeder for precision monoseeding of wheat, wherein the seeder sets wheat row spacing to be 4-6 cm, plant spacing to be 3-5 cm, and seeding depth to be 3-4 cm, and when seeding, timely compaction after seeding is required to ensure the compaction pressure and quality.

2. The uniform monoseeding and cultivation method of winter wheat according to claim 1, wherein seeding is in early-to-mid October, and harvesting is from the end of May through early-to-mid June.

3. The uniform monoseeding and cultivation method of winter wheat according to claim 1, wherein, in step (1), the deep tillage is carried out once every two years.

4. The uniform monoseeding and cultivation method of winter wheat according to claim 2, wherein, in step (1), the deep tillage is carried out once every two years.

5. The uniform monoseeding and cultivation method of winter wheat according to claim 1, wherein in step (1), the wheat has a long growth period and high water requirement, and before seeding, 30 m³/mu water is irrigated to moisten the soil.

6. The uniform monoseeding and cultivation method of winter wheat according to claim 2, wherein in step (1), the wheat has a long growth period and high water requirement, and before seeding, 30 m³/mu water is irrigated to moisten the soil.

7. The uniform monoseeding and cultivation method of winter wheat according to claim 1, wherein in step (1), for large clods in a plot, further harrowing is required to make topsoil depth consistent.

8. The uniform monoseeding and cultivation method of winter wheat according to claim 2, wherein in step (1), for large clods in a plot, further harrowing is required to make topsoil depth consistent.

9. The uniform monoseeding and cultivation method of winter wheat according to claim 1, wherein in step (2), the seeder sets the wheat row spacing to be 5 cm, the plant spacing to be 3 cm, and the seeding depth to be 3 cm.

10. The uniform monoseeding and cultivation method of winter wheat according to claim 2, wherein in step (2), the seeder sets the wheat row spacing to be 5 cm, the plant spacing to be 3 cm, and the seeding depth to be 3 cm.

11. The uniform monoseeding and cultivation method of winter wheat according to claim 1, wherein in step (2), before seeding, 1% shenqinmycin is used for seed dressing.

12. The uniform monoseeding and cultivation method of winter wheat according to claim 2, wherein in step (2), before seeding, 1% shenqinmycin is used for seed dressing.

13. The uniform monoseeding and cultivation method of winter wheat according to claim 1, wherein in step (2), seeding rate is controlled at 30-40 catty/mu, and more preferably 35 catty/mu.

14. The uniform monoseeding and cultivation method of winter wheat according to claim 2, wherein in step (2), seeding rate is controlled at 30-40 catty/mu, and more preferably 35 catty/mu.

15. The uniform monoseeding and cultivation method of winter wheat according to claim 1, wherein in step (1), the seeder is a wheat uniform monoseeder trial.

16. The uniform monoseeding and cultivation method of winter wheat according to claim 2, wherein in step (1), the seeder is a wheat uniform monoseeder trial.
